(19) United States
(12) Patent Application Publication
(10) Pub. No.: US 2023/0114282 A1
(43) Pub. Date: Apr. 13, 2023

(54) SLUDGE DRYING SYSTEM

(71) Applicant: FJELL TECHNOLOGY GROUP AS, Bergen (NO)

(72) Inventor: Asbjørn STRAND, Bergen (NO)

(21) Appl. No.: 17/799,453

(22) PCT Filed: Feb. 16, 2021
(86) PCT No.: PCT/EP2021/053743

§ 371 Date: Aug. 12, 2022

(30) Foreign Application Priority Data
Feb. 17, 2020 (GB) 2002145.7

(51) Int. Cl. C02F 11/13; C02F 11/18; F26B 17/20; F26B 25/00; F26B 23/00; F26B 1/00; B01D 1/28; B01D 53/14

(52) U.S. Cl. CPC C02F 11/13; B01D 1/2846; B01D 53/14; C02F 11/18; F26B 1/00; F26B 17/20; F26B 23/004; F26B 25/005; C02F 2209/02; C02F 2209/03; C02F 2301/08; C02F 2301/043; C02F 2301/046; C02F 2303/04; C02F 2303/10; F26B 2200/18

(57) ABSTRACT

Disclosed herein is a sludge drying system comprising: a system input for receiving a wet sludge stream, wherein the wet sludge stream comprises water and solid material; a first dryer arranged to receive, at an input of the first dryer, the wet sludge stream and to heat the wet sludge stream such that at least part of the water in the wet sludge stream is evaporated to thereby generate evaporate and a partially dry sludge stream, wherein the first dryer is an indirectly heated rotating disc dryer that comprises a first output for outputting evaporate and a second output for outputting the partially dry sludge stream; a second dryer that is an indirectly heated rotating disc dryer and is arranged to receive, at a first input of the second dryer, a stream that is dependent on the partially dry sludge stream output from the first dryer and to receive, at a second input of the second dryer, the evaporate from the first dryer, wherein the second dryer is arranged to use to the received evaporate to indirectly heat the received stream at the first input to thereby generate and output a substantially dry sludge stream; and a system output for outputting at least part of the substantially dry sludge stream from the system.

### FIELD OF INVENTION

The present invention relates to techniques for drying sludge.

### BACKGROUND

The drying of sludge is required in many industries. For example, industrial scale dryers may be used for waste water treatment, sewage treatment, aquaculture waste treatment (such as fish farm waste treatment), the general treatment of industrial waste output and in food preparation (such as animal and fish feed preparation).

It is known for disc dryers, such as steam-heated rotating disc dryers, to be used for the drying of sludge. A steam-heated rotating disc dryer is disclosed in US2,883,163A, the entirety of which is incorporated herein by reference. Known disc dryers also include dryers manufactured by Fjell Technology Group AS: http://www.fjelltg.no/products/fjellturbodiscdryer/ (as viewed on 14^{th} February 2020), and dryers manufactured by Haarslev: https://haarslev.com/products/disc-dryer/ (as viewed on 14^{th} February 2020). Known solutions for drying sludge also include friction dryers such as that described in patent WO02/093094A1, the entirety of which is incorporated herein by reference.

There are a number of technical challenges associated with the drying of sludge. For some types of sludge, problems may be caused by the properties of the sludge including a glue zone, as described in WO 02/093094A1. Furthermore, friction dryers are typically operated by large electrical motors that generate heat by friction. There is therefore no, or limited, waste heat recovery.

There is therefore general need to improve the operating efficiency of sludge dryers.

### SUMMARY OF INVENTION

Aspects of the invention are set out in the independent claims.

Optional features are set out in the dependent claims.

### BRIEF DESCRIPTION OF THE DRAWINGS

The accompanying drawings, which are incorporated herein and form part of the specification, illustrate embodiments of the invention and serve to clarify some aspects of embodiments of the invention and to enable a skilled person in the relevant art(s) to make and use embodiments of the invention.

FIG. 1 is a schematic diagram of a sludge drying system according to an embodiment of the invention.

### DETAILED DESCRIPTION OF THE INVENTION

Embodiments of the invention provide a heat-efficient sludge drying system and method. Embodiments of the invention may be capable of drying sludge from a wet sludge stream to a substantially dry sludge stream. Embodiments may provide a more energy efficient sludge drying system than known techniques.

The sludge drying system according to embodiments comprises at least two dryers. A wet sludge stream is indirectly heated in a first dryer. Water is evaporated from the wet sludge stream in the first dryer to generate a partially dry sludge stream that is output from the first dryer. The partially dry sludge stream is then fed into a second dryer. The evaporated water in the first dryer is used to indirectly heat the sludge in the second dryer. The use of the heat in the evaporated water generated in the first dryer for indirect heating in the second dryer provides an energy efficient sludge drying system.

Sludge is a wet solid product that comprises water and solid material. Sludge may, for example, come from a water treatment plant and may be at least partially dewatered in, for example, a decanter centrifuge, filter press or screw press. Applications of sludge drying systems according to embodiments include, but are not limited to, the drying of sludge from municipal waste water treatment plants, the drying of sludge comprising human waste (such as in sewage treatment plants), the drying of sludge comprising agricultural and/or aquacultural waste (for example from fish farms), the drying of sludge in industrial effluent treatment plants, the drying of sludge from the mining industry, the drying of sludge in the food preparation industry, the drying of sludge for water treatment in the fish farming industry and the drying of products from the brewing and distilling industry. In particular, the sludge may comprise fish, for example cut-offs and offal from fish and/or processed fish, and/or animal products from slaughterhouses. Such a sludge may be used in the production of, for example, animal and/or fish meal. Sludge may generally be any viscous mixture of water and organic and/or inorganic material where a major part of the dry solids is in suspension and not solution.

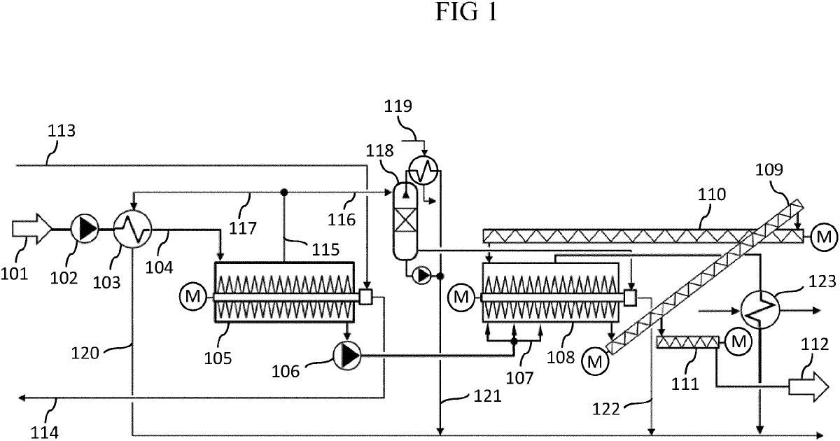

FIG. 1 is a schematic diagram illustrating a sludge drying system according to an embodiment.

The sludge drying system comprises an input 101 for receiving a wet sludge stream.

The wet sludge stream is fed to a first dryer 105.

Between the input 101 and the first dryer 105, the wet sludge stream may be fed through a pre-heater 103 that heats the wet sludge stream. The pre-heater 103 may indirectly heat the wet sludge stream with some of the evaporate from the first dryer 105 and thereby both heat the wet sludge stream and condense the evaporate. Alternatively, the pre-heater 103 may directly mix the evaporate and the wet sludge stream. Although not shown in FIG. 1, an additional mechanical dewatering mechanism may be provided between the pre-heater 103 and the first dryer 105 to remove condensate from the wet sludge stream. Embodiments also include the pre-heater 103 heating the wet sludge stream according to any known technique.

In FIG. 1, flow path 104 is a pre-heated flow of a wet sludge stream to the first dryer 105.

The flow path of the wet sludge stream from the input 101 to the first dryer 105 may comprise any suitable feed pump 102 as is known in the art. A suitable such pump is a positive displacement pump such as a piston pump, a lamella pump, a lobe pump, a reciprocal pump or a progressive cavity pump.

The wet sludge stream that is fed into the first dryer 105 may have a dry solids (DS) content of about 15-35%DS. The wet sludge stream is heated in the first dryer 105 and output as a partially dry sludge stream. The partially dry sludge stream may have a DS content of about 40-50%DS. The DS content of the partially dry sludge stream that the first dryer 105 is configured to output depends on the type of sludge that is being dried. When used with types of sludge that have a glue zone (as described in WO 02/093094A1), the first dryer 105 is preferably configured to generate partially dry sludge with a DS content that is below the level at which the sludge is in a glue zone.

The first dryer 105 may be an indirectly heated dryer, such as a steam heated rotating disc dryer. The first dryer 105 may comprise a plurality of heated discs mounted on a pipe rotating inside a closed chamber. In particular, the first dryer 105 may be a steam-heated rotating disc dryer, for example based on that disclosed in patent US2,883,163A, the entirety of which is incorporated herein by reference. The first dryer 105 may be, for example, based on: a known dryer as manufactured by Fjell Technology Group AS: http://www.fjelltg.no/products/fjellturbodiscdryer/ (as viewed on 14^{th} February 2020), a known dryer as manufactured by Haarslev: https://haarslev.com/products/disc-drver/ (as viewed on 14^{th} February 2020), or any other suitable known dryers. The first dryer 105 may alternatively be an electrically heated dryer or a dryer heated by thermal oil, hot water or any type of indirectly heated dryer.

When the first dryer 105 is in use, the sludge is located in an indirectly heated processing chamber of the first dryer 105. The processing chamber is preferably sealed such that no volatiles from the sludge can contaminate other parts of the first dryer 105.

In embodiments in which the first dryer 105 is a steam-heated dryer, the condensate formed as the steam gives up its heat in the first dryer 105 may be returned to the heating system for generating the steam, i.e. the steam boiler. The steam and condensate may therefore be circulated in a closed loop, provide by flow path 113 and flow path 114, for the first dryer 105. In this case, the steam chamber of the first dryer 105 is preferably sealed to maintain an substantially clean steam atmosphere, free from water vapour and any other volatiles from the sludge.

The partially dry sludge output from the first dryer 105 is viscous. This sludge is fed from the first dryer 105 to a second dryer 108 by discharging means 106. The discharge of the partially dry sludge may be controlled, for example, by means of a combination of screw conveyors and/or suitable positive displacement pumps such as piston pumps, lamella pumps, lobe pumps, reciprocal pumps or progressive cavity pumps.

The second dryer 108 is steam-heated dryer in which the sludge is indirectly heated. The second dryer 108 may be a disc dryer with steam-heated discs mounted on a pipe rotating inside a closed chamber. The second dryer 108 may thus comprise a sealed steam chamber formed by the internal surface of the discs in which steam is used to heat the discs. The second dryer 108 may also comprise a separate processing chamber on the outside of the discs in which the sludge is located when in use. Each of the steam chamber and the processing chamber may be sealed such that there can be no contamination of the steam in the steam chamber by volatile gases from the sludge in the processing chamber.

The second dryer 108 may be a dryer based on that disclosed in patent US2,883,163A, the entirety of which is incorporated herein by reference. The second dryer 108 may be, for example, based on: a known dryer as manufactured by Fjell Technology Group AS: http://www.fjelltg.no/products/fjellturbodiscdryer/ (as viewed on 14^{th} February 2020), a known dryer as manufactured by Haarslev: https://haarslev.com/products/disc-drver/ (as viewed on 14^{th} February 2020), or any other suitable known dryers.

In the second dryer 108, the sludge is indirectly heated by the steam-heated discs to form a substantially dry sludge. The substantially dry sludge may have a solid content of about 80-95% dry solids. The substantially dry sludge may be in the form of a dry powder such as a granulate.

The substantially dry sludge is then discharged from the second dryer 108 in a discharge stream 112. The discharge may be performed using one or more conveyors 111.

In embodiments, the evaporate formed by evaporating water from the sludge in the first dryer 105 is used to steam-heat the second dryer 108. Thus, the waste heat in the evaporate is utilised and the total required steam input to the system is reduced. This provides a heat efficient system for drying sludge. Compared to a system in which the sludge is dried in a single dryer without re-use of waste heat, a significant energy saving can be achieved.

At least part of a stream of evaporate 115 formed in the first dryer 105, from the evaporated water in the wet sludge, is fed to the steam chamber of the second dryer 108 and is used to indirectly heat the sludge in the second dryer 108. Typically, this stream of evaporate is evaporated water with small particles of sludge, traces of other volatile constituents from the sludge, for example ammonia, and any air that has entered the dryer. In some cases other volatile materials may be vaporized such as organic acids, alcohols or solvents. Condensate formed in the steam chamber when the evaporate gives up its heat is then bled off in a condensate stream 122.

To avoid structural damage to the second dryer 108 by corrosion, and/or build-up of residues on the internal walls of the steam chamber due to the particles in the evaporate, cleaning of the evaporate may be performed prior to it being fed into the second dryer 108. Because the evaporate is to be used inside the steam chamber of the second dryer 108, the evaporate should be substantially clean in order to keep fouling on the heat transfer surfaces to a minimum.

An appropriate cleaning apparatus 118 may be used for cleaning the evaporate. This may be a conventional scrubber, for example a wet scrubber, that washes out any dust, dirt and/or pollutants from the evaporate.

In some embodiments, the scrubber may comprise spray nozzles and in some cases a packing. The scrubber may wash out dust, dirt and/or pollutants. The scrubber may be a closed loop system for washing out dust, dirt and/or pollutants by recirculating condensate of the evaporate in the scrubber through the nozzles and/or packing in the scrubber. As shown in FIG. 1, the evaporate and recirculated condensate may be fed into a top compartment of the scrubber and the flow of evaporate and condensate through the packing may be a co-flow. Embodiments also include the evaporate being fed into a bottom compartment of the scrubber and the recirculated condensate fed into a top compartment of the scrubber. The packing is arranged between the top compartment and the bottom compartment so that the flow of evaporate and condensate through the packing may be a counter-flow. The evaporate is therefore sprayed with the condensate as it flows up through the packing. The scrubber may also comprise a demister that the evaporate flows through before flowing out of the scrubber. The demister removes liquid droplets from the evaporate.

The condensate circulating in the cleaning apparatus 118 may be cooled slightly in a heat exchanger by a small stream of coolant 119, so that sufficient condensate to maintain a good washing effect of the steam in the scrubber is formed. The coolant may be a liquid or air. The amount of coolant may be controlled by conventional sensors and control valves. Condensate 121 may also be slowly bled off from the cleaning apparatus 118. The flowrate of this may also be controlled by conventional sensors and control valves. The amount of recirculated condensate may be automatically controlled by liquid level sensors and a controller.

The scrubber may alternatively be a non-closed system for cleaning the steam. Alternative cleaning apparatuses are cyclones, rotating dust mops or filters of some sort. Another alternative is to use a condensing heat exchanger to perform the function of the cleaning apparatus 118, in that heat is transferred from the evaporate to a clean stream of steam by means of closed heat loops. The clean stream of steam is then used to heat the second dryer 108.

In embodiments without a cleaning apparatus 118, the evaporated steam in the first dryer 105 may be directly fed into the steam chamber of the second dryer 108. This may be appropriate for certain types of sludge in which the evaporate from the first dryer 105 is sufficiently clean for use in the second dryer 108.

As sludge is dried, the sludge may go through a glue zone, that may also be referred to as a glue-phase, in which it forms a very viscous glue-like dough which induces high shear and friction forces in the drying device. The sludge may also have very poor heat transfer characteristics in this glue zone. The glue zone is typically encountered in sludge with a solid content of about 50-70% dry solids, as described in WO02/093094A1 which is incorporated herein in its entirety.

It is typically difficult to dry sludge that is in the glue zone. To solve this problem, the first dryer 105 may be arranged to dry the wet sludge up to a dryness level before the sludge enters its glue zone. This ensures good heat transfer characteristics of the sludge in the first dryer 105 and limits the wear and tear of the first dryer 105. To overcome the difficulties in the glue zone while further drying the partially dry sludge in the second dryer 108, already dried sludge discharged from the second dryer 108 may be fed back to the sludge input of the second dryer 108. The amount of recirculated dried sludge should be sufficient such that, when mixed with the partially dry sludge that is input to the second dryer 108, the overall solid content of the sludge stays above the upper limit of the glue-phase. This process is described in WO02/093094A1 which is incorporated herein in its entirety. Accordingly, the second dryer 108 may always be operating with sludge that has a solid content higher than that in the glue zone. The drying of sludge that is in the glue zone may thereby be avoided.

In embodiments, the substantially dry sludge output from second dryer 108 may thus be recirculated. This may be done using one or more screw conveyors 109 and 110, or other type of granulate transport systems capable of recycling the substantially dry sludge from the second dryer 108 outlet to an inlet of the second dryer 108. The recycled substantially dry sludge may be mixed with the partially dry sludge either inside or outside of the second dryer 108. The amount of substantially dry sludge that is recycled may be adjusted and controlled so that the solids content after mixing is above the glue phase limit. This enables sludge to be dried by the second dryer 108 without severe wear and tear of the second dryer 108.

For some types of sludge, that may include fish based sludge used in fish and animal feed preparation, the above techniques are not required to avoid the glue zone of the sludge. The sludge may not form a glue-like dough, or may form a glue-like dough only to a small extent. Embodiments therefore also include the second dryer 108 being operated without any of the output substantially dry sludge being recycled.

In some embodiments, the first dryer 105 and the second dryer 108 may be operated at different pressures and/or temperatures. In the first dryer 105, the operating pressure and/or temperature in its processing chamber may be higher than the operating pressure and/or temperature in the processing chamber of the second dryer 108. For example, the second dryer 108 may be operated at atmospheric pressure while the first dryer 105 is pressurised. Alternatively, the first dryer 105 may be operated at atmospheric pressure while the second dryer 108 is operated under partial vacuum. One or more of the dryers may be structurally adapted so that it can be pressurised. For example, the seals and connections may be made stronger than for similar dryers that do operate under pressurised conditions.

In some embodiments, the first dryer 105 may be operated at about 1 to 8 bar absolute, about 1 to 5 bar absolute, about 2 to 4 bar absolute, and/or about 3 bar absolute while the second dryer 108 may be operated at atmospheric pressure. In some embodiments, the first dryer 105 may be operated at atmospheric pressure while the second dryer 108 is operated at about between 0 to 1 bar absolute, about 0.01 to 0.5 bar absolute, and/or about 0.1 to 0.3 bar absolute.

Operating the first dryer 105 at a higher pressure and/or temperature than the second dryer 108 may improve the heat efficiency of the re-use of waste heat from the first dryer 105 in the second dryer 108.

Operating at a higher than atmospheric pressure in the first dryer 105 may also promote thermal hydrolysis of the glue forming organic macromolecules in the sludge. This may reduce the tendency to form the glue-like dough in the glue zone and thereby make the drying process of the sludge easier. For example, it may be possible to operate the first dryer 105 with a higher output DS content before the glue-phase starts to develop. For example, the output partially dry sludge may comprise about 45-55% dry solids. Also, the amount of substantially dry sludge that needs to be recycled in the second dryer 108 may be reduced and the mechanical load, tear and wear in the second dryer 108 may be reduced.

Additionally, an elevated operating pressure and/or temperature in the first dryer 105 may aid the full sterilisation of the sludge so that the dried sludge can later safely be used as, for example, fertiliser or landfill. The elevated operating pressure and/or temperature may, for example, kill bacteria efficiently as the sludge is dried in the system. This may help to meet regulations for the manufacturing of products such as fertiliser or landfill.

Operating the two dryers at different pressures and temperatures may also improve the overall heat balance in the system. The thermal hydrolysis in the first dryer 105 may increase the limit for maximum dry solids content in the partially dry sludge and thereby a larger portion of the total evaporation can be performed in the first dryer 105. More waste heat is therefore available in the evaporate from the first dryer 105 and less heat is needed in the second dryer 108. There are also advantages in the dimensioning and operational expenditures of the drying equipment, for example because the heat surfaces in the second dryer 108 may be reduced.

In embodiments in which the second dryer 108 is operated at a lower pressure than the first dryer 105, flash evaporation of the partially dry sludge may occur as it is fed from the first dryer 105 to the second dryer 108. The pressurised partially dry sludge may be passed through a manifold and expanded through at least one nozzle or valve 107, and this may cause flash evaporation of the partially dry sludge. The partially dry sludge may thereby be sprayed into the second dryer 108 at high velocity. This may allow effective mixing of the partially dry sludge with the recycled substantially dry sludge in the second dryer 108. This may be done by an arrangement of manifolds and injection nozzles designed so that the partially dry sludge may be flash evaporated. In some embodiments, the nozzles, such as Venturi nozzles, may be arranged such that the flash evaporated partially dry sludge stream is sprayed horizontally into the second dryer 108 (which has a horizontally aligned longitudinal axis). The flash evaporated partially dry sludge stream may be sprayed horizontally through an end of the second dryer 108 into the vapour dome at the top of the second dryer 108. The effect of spraying the stream of partially dry sludge may cause it to be spread over a plurality of the rotating discs in the second dryer 108. The substantially dry sludge may be fed into the second dryer 108 through openings in the top of the second dryer. The openings may be arranged substantially over the region that the partially dry sludge is sprayed over so that as the substantially dry sludge flows vertically downwards into the second dryer 109 it crosses the substantially horizontal sprayed stream of partially dry sludge. This may enhance the mixing of the partially dry sludge and the recycled substantially dry sludge.

As described earlier, in some embodiments part of the evaporate from the first dryer 105 may be used to pre-heat the wet sludge stream in a pre-heater 103 before the wet sludge stream is fed into the first dryer 105. The stream 115 of evaporate output from the first dryer 105 may therefore then be split up into two separate streams, namely a first stream 116 used to heat the second dryer 108 and a second stream 117 used to heat the wet sludge stream in the pre-heater 103. Preferably, the sludge drying system is heat balanced so that the first dryer 105 is arranged to produce enough evaporate to heat both the pre-heater 103 and the second dryer 108. Further, if thermal hydrolysis is promoted in the first dryer 105, more heat in the evaporate will be available due to the rise in the limit for maximum dry solids content in the partially dry sludge, such that a larger amount of pre-heating may be performed. By pre-heating the wet sludge stream, more waste heat may be recovered from the evaporate. This may result in a more heat efficient process. The pre-heater 103 may be any suitable heat exchanger able to efficiently condense a stream of evaporate from the first dryer 105. A stream of condensate 120 may thus be bled from the pre-heater 103 when the evaporate gives up its heat to pre-heat the wet sludge stream.

In some embodiments, the sludge drying system may comprise a condensing system 123 for condensing the water evaporated from the sludge in the second dryer 108.

Embodiments may be used for producing animal and/or fish meal in a more efficient way. The wet sludge stream may, for example, be a sludge stream comprising processed fish, for example processed cut-offs and offal from fish. The dry sludge may then comprise fish meal. In addition, substances for vitamin pills, such as Omega 3, may be produced in the sludge drying and related processes. It may be beneficial to operate the first dryer 105 at atmospheric pressure and the second dryer 108 at below atmospheric pressure when producing animal and/or fish meal. The sludge formed may substantially not experience a glue-phase and so it may not be necessary to recycle the substantially dry sludge in the second dryer 108.

Embodiments include a number of modifications and variations to the above described techniques.

In particular, embodiments include more than two dryers being used to dry the sludge. The evaporate from each dryer may be used for indirect heating in another dryer. For example, the evaporate output from the second dryer 108 may be used for indirect heating of sludge output from the second dryer 108 in a third dryer.

Embodiments also include the use of mechanical vapour recompression (MVR) to further heat, i.e. superheat, the evaporate from the first dryer 105 before it enters the second dryer 108. Mechanical vapour recompression may be used to superheat the evaporate output from the first dryer 105 before it is input into the cleaning apparatus 118, and/or to superheat the cleaned evaporate output from the cleaning apparatus 118. This may be achieved by any suitable known mechanical vapour recompression technique. In embodiments where mechanical vapour recompression is used, the temperature of the evaporate may be about 10 to 30 K higher than when mechanical vapour recompression is not used. The heat transfer in the second dryer 108 may thereby be improved.

In the second dryer 108, it may be desirable to have a large temperature difference between the evaporate from the first dryer 105 that is heating the second dryer 108 and the partially-dried sludge that is being heated. The evaporate from the first dryer 105 is at substantially its boiling point and at the operating pressure of the first dryer 105, whereas the partially-dried sludge is at substantially the boiling temperature of water and at the operating pressure of the second dryer 108. In order to achieve a large temperature difference between the evaporate from the first dryer 105 that is heating the second dryer 108 and the partially-dried sludge that is being heated, the second dryer 108 may operate at a lower pressure than the first dryer 105 so that the boiling point in the second dryer 108 is lower than the boiling point in the first dryer 105. An advantage of using mechanical vapour recompression is that it may substantially reduce the required difference in operating pressures between the first dryer 105 and the second dryer 108. By superheating the evaporate, a particular temperature difference may be achieved with a lower pressure difference, and therefore boiling point difference, in the first dryer 105 and the second dryer 108.

For example, a temperature difference of 50 K may be desired between the first dryer 105 and the second dryer 108. Without mechanical vapour recompression, if the first dryer 105 operates at atmospheric pressure (with a boiling point of 100° C.), the second dryer 108 has to operate at about 0.1 bara to achieve the desired temperature difference. If, however, mechanical vapour recompression is used to further heat the evaporate to about 115 to 120° C., the second dryer 108 may instead operate at 0.3 bara (which has a boiling point of about 70° C.).

Alternatively, the second dryer 108 may operate at atmospheric pressure (with a boiling point of 100° C.). Without mechanical vapour recompression it may then be necessary to operate the first dryer 105 at almost 5 bara to obtain a difference of 50 K in boiling temperature. However, with mechanical vapour recompression, the first dryer 105 may instead be operated at about 3 bara to produce evaporate at a temperature of 133° C. , which may then be superheated by the mechanical vapour recompression techniques to 150° C. , in order to achieve an overall temperature difference of 50 K.

Embodiments also include operating both the first dryer 105 and the second dryer 108 at atmospheric pressure and using mechanical vapour recompression techniques to further heat the evaporate between the first dryer 105 and the second dryer 108.

Embodiments also include the heat from the evaporate from the first dryer 105 being used in the second dryer 108, but the evaporate from the first dryer 105 not being used in the second dryer 108. The evaporate from the first dryer 105 may be passed through a heat exchanger, such as a conventional finned tube heat exchanger, that may at least partly condense the evaporate. Within the heat exchanger, the heat in the evaporate may be used to indirectly heat a separate fluid stream, that may be an air stream. The second dryer 108 may be a conventional dryer, such as an air dryer, that receives the fluid stream from the heat exchanger and uses it to dry sludge. The second dryer 108 may be arranged to directly heat the sludge or indirectly heat the sludge. In this embodiment, the first dryer 105 may be operated at atmospheric pressure. The temperature of the fluid stream received by the second dryer from the heat exchanger may be 70-80° C. An advantage of this embodiment is that it is not necessary to clean the evaporate from the first dryer 105.

Other embodiments of the invention will be apparent to those skilled in the art from consideration of the specification and practice of the embodiments disclosed herein. It is intended that the specification and examples be considered as exemplary only, with a true scope and spirit of the invention being indicated by the following claims.

1. A sludge drying system comprising:
a system input for receiving a wet sludge stream, wherein the wet sludge stream comprises water and solid material;
a first dryer arranged to receive, at an input of the first dryer, the wet sludge stream and to heat the wet sludge stream such that at least part of the water in the wet sludge stream is evaporated to thereby generate evaporate and a partially dry sludge stream, wherein the first dryer is an indirectly heated rotating disc dryer that comprises a first output for outputting evaporate and a second output for outputting the partially dry sludge stream;
a second dryer that is an indirectly heated rotating disc dryer and is arranged to receive, at a first input of the second dryer, a stream that is dependent on the partially dry sludge stream output from the first dryer and to receive, at a second input of the second dryer, the evaporate from the first dryer, wherein the second dryer is arranged to use to the received evaporate to indirectly heat the received stream at the first input to thereby generate and output a substantially dry sludge stream;
a system output for outputting at least part of the substantially dry sludge stream from the system; and
a cleaning apparatus arranged in a fluid flow path between the first output of the first dryer and the second input of the second dryer to clean the evaporate.

2. The sludge drying system according to claim 1, wherein the first dryer is a steam -heated dryer.

3. The sludge drying system according to claim 1, wherein the first dryer is a steam-heated dryer, and the system further comprises a heating system for generating steam for the indirect heating in the first dryer; and
the first dryer further comprises:
a steam input for receiving steam from the heating system; and
a third output for condensate that is generated by the received steam condensing in the first dryer;
wherein the system comprises a flow path between the first dryer and the heating system that is arranged to return the condensate from the third output of the first dryer to the heating system.

4. (canceled)

5. The sludge drying system according to claim 1, wherein the cleaning apparatus is a scrubber such as a wet scrubber.

6. The sludge drying system according to claim 1, wherein the cleaning apparatus comprises:
a first input for evaporate;
a first output for evaporate;
a second output for condensate that has been generated by the evaporate received by the cleaning apparatus condensing in the cleaning apparatus; and
a second input for receiving at least part of the condensate output from the second output of the cleaning apparatus;
wherein the cleaning apparatus is arranged such that, within the cleaning apparatus, evaporate received at the first input is washed with the condensate received at the second input.

7. The sludge drying system according to claim 1, wherein the stream that is indirectly heated in the second dryer comprises a mixture of sludge from the substantially dry sludge stream output from the second dryer and sludge from the partially dry sludge stream output from the first dryer;
wherein the sludge from the substantially dry sludge stream is mixed with the sludge from the partially dry sludge stream in a ratio that is between 1: 1 to 10: 1, and preferably between 3: 1 to 5: 1;
wherein the second dryer further comprises a third input arranged to receive at least part of the substantially dry sludge stream output from the second dryer; and
wherein the system further comprises a mixer arranged in a fluid flow path between the first dryer and the second dryer, wherein the mixer is configured to:
receive at least part of the partially dry sludge stream output from the first dryer;
receive at least part of the substantially dry sludge stream output from the second dryer;
mix the received partially dry sludge stream and substantially dry sludge stream; and
to output the mixed streams to the second dryer.

8-10. (canceled)

11. The sludge drying system according to claim 1, the system further comprising a pre -heater arranged in a fluid flow path between the system input and the input of the first dryer for a wet sludge stream;
wherein the pre-heater is arranged to use at least some of the evaporate from the first output of the first dryer to indirectly heat the wet sludge stream.

12. The sludge drying system according to claim 1, wherein the operational pressure within the first dryer and the operational pressure within the second dryer are different.

13. The sludge drying system according to claim 1, wherein the second dryer is operated substantially at atmospheric pressure and the first dryer is operated at a higher pressure than atmospheric pressure.

14. The sludge drying system according to claim 1, wherein the first dryer is operated at atmospheric pressure and the second dryer is operated at a lower pressure than atmospheric pressure.

15. The sludge drying system according to claim 1, wherein the operational temperature within the first dryer and the operational temperature within the second dryer are different.

16. The sludge drying system according to claim 1, wherein the pressure difference between the first and second dryers is arranged such that, in a fluid flow path between the second output of the first dryer and the first input of the second dryer, the partially dry sludge stream flash evaporates.

17. The sludge drying system according to claim 1, wherein the first input of the second dryer is arranged such that the partially dry sludge stream is sprayed into the second dryer.

18. The sludge drying system according to claim 1, wherein:
the first dryer is configured such that the operational temperature within the first dryer is between about 100 and about 150° C.; and/or
the second dryer is configured such that the operational temperature within the second dryer is between about 50 and about 100° C.

19. The sludge drying system according to claim 1, wherein the first dryer is configured such that the operational absolute pressure within the first dryer is between about 1 and about 5 bar.

20. The sludge drying system according to claim 1, wherein the second dryer is configured such that the operational absolute pressure within the second dryer is between about 0.1 and about 1 bar.

21. The sludge drying system according to claim 1, wherein the first dryer is configured such that hydrolysis of the sludge within the first dryer is promoted by the operational temperature and/or pressure within the first dryer.

22. The sludge drying system according to claim 1, wherein the first dryer and/or the second dryer are configured such that the sludge is sterilised by the operational temperatures and/or pressures.

23. The sludge drying system according to claim 1, wherein the evaporate from the first dryer is further heated by a mechanical vapour recompression technique before being received by the second dryer.

24. A method of drying of sludge, wherein the method comprises:
receiving a wet sludge stream that comprises water and solid material;
indirectly heating the wet sludge stream, by a first dryer, such that at least part of the water in the wet sludge stream is evaporated to generate evaporate;
outputting a partially dry sludge stream;
outputting and cleaning the evaporate;
using, by a second dryer, the cleaned evaporate from the first dryer to indirectly heat the partially dry sludge stream to generate substantially dry sludge; and
outputting a stream of the generated substantially dry sludge.

25. (canceled)

26. (canceled)
